(19) United States
(12) Patent Application Publication
(10) Pub. No.: US 2026/0354625 A1
(43) Pub. Date: Nov. 12, 2026

(54) COMPACT CREAM MACHINE FOR LOADING KITCHEN SIPHONS FOR WHIPPED CREAM

(71) Applicant: Octavio Adolfo MUÑOZ FUENTEALBA, San Pedro de la Paz (CL)

(72) Inventor: Octavio Adolfo MUÑOZ FUENTEALBA, San Pedro de la Paz (CL)

(21) Appl. No.: 19/719,602

(22) Filed: Jun. 25, 2026

Related U.S. Application Data
(63) Continuation of application No. PCT/CL2025/050016, filed on Feb. 6, 2025.
(63) Continuation of application No. PCT/CL2024/050180, filed on Dec. 27, 2024.

(30) Foreign Application Priority Data
Jan. 2, 2024 (CL) 202400002
Feb. 21, 2024 (CL) 202400533

(51) Int. Cl. A47J 43/12; A23P 30/40; B01F 23/237

(52) U.S. Cl. CPC A47J 43/128; A23P 30/40; B01F 23/2376

(57) ABSTRACT

A compact creamer machine (1) for loading kitchen siphons for whipped cream by injection of nitrous oxide, installed or supported on a countertop, allowing remote monitoring of the total number of loads, the date of the last load, and cylinder usage. The machine comprises an information display, a control keypad, and connections for gas handling; a creamer base (3) defined by a top and bottom walls (13, 14), side covers (11, 12), and a rear cover (21) made of acrylic, forming a closed housing supported on skids (13), a hose inlet cover (15) from the loading cylinder, screwed to the outer surface of said bottom wall (14), and on the top wall (8) protrudes a solenoid valve (10) that regulates the supply to the siphon (5); and a scale integrated into the base of the machine, allowing the operator to weigh the cream to perform an exact load.

### CROSS REFERENCE TO RELATED APPLICATIONS

This application is a bypass continuation of International Patent Application No. PCT/CL 2024/050180 filed Dec. 27, 2024, which claims the benefit of priority from Chilean Patent Application No. 20240002, filed Jan. 2, 2024, and International Patent Application No. PCT/CL 2025/050016, filed Feb. 6, 2025, which claims the benefit of priority from Chilean Patent Application No. 202400533, filed Feb. 21, 2024, the contents of each of which are incorporated herein by reference.

### FIELD OF THE INVENTION

The present invention aims to provide a compact machine that allows loading siphons for whipped cream, by means of the automatic injection of nitrous oxide, from at least one cylinder of at least half a kilogram of nitrous oxide.

### BACKGROUND OF THE INVENTION

The kitchen siphon is an instrument used to make foams, invented by Ferran Adrià in 1985, based on the already existing beverage siphon that was used to carbonate liquids.

They are made of stainless steel or aluminum with metallic or synthetic parts, resistant to dishwashers. Classically, a siphon comprises at least a fluid container, a head, a funnel, and one or more gas cartridges, which are usually identified as chargers.

The first thing to keep in mind are the parts that make up the siphon. We have the body of the siphon and the head of the device. The charges and dispensers are inserted into the head. The body of the device consists of a container, available in half-liter, one-liter, and one-and-a-half-liter sizes, normally made of stainless steel, making it suitable for hot and cold preparations. The head makes it possible to prevent the gas mixture we introduce into the preparations from escaping. Three types of nozzles are inserted, used depending on the purpose of the product and, above all, how we wish to decorate it. We can make smooth or ribbed designs. The charges are what make it possible to prepare foams, whipped cream, mousses, creams, etc. They are nitrous oxide (N₂O) cartridges, a colorless gas with a sweet smell, and each charge generally serves for ½ liter of product and is usually supplied in sealed cartridges (“chargers”), which are opened when the cartridge is inserted into the siphon, thereby breaking a seal and releasing its charge into the siphon. It is then important to shake the device vigorously 3 or 4 times up and down.

The foams that can be prepared with siphons are basically of three types, identified by the base used, that is, whether the base is fat, gelatin, or egg whites and yolks. With fats and gelatins, cold foams can be obtained. The main ingredient can be a fruit, juice, purée, nuts, spices, etc. And with egg whites and yolks, it is possible to obtain, in addition to cold foams, hot foams with the same main ingredients.

In the prior art, patent EP1428791B1 by Ládi Zsolt Dr. is known, which illustrates a conventional kitchen siphon typical of the prior art, composed basically of a container with a dispensing nozzle, in which means are defined that allow coupling a gas cartridge, which, once it releases its gas charge, allows the product contained in the container to be dispensed.

In WO2009112706 A by Lion Mathieu, there is a kitchen apparatus of the siphon type for Chantilly cream, comprising a fluid container, a head, a funnel, and at least one gas cartridge. The apparatus according to the invention comprises a support for its placement, with a base in which are defined: at least one hollow housing to receive the said funnel and the said fluid container, in an aeration position of both elements; a stop to position the said head, also in an aeration position; and at least one cavity suitable for accommodating a gas cartridge.

A more recent embodiment corresponds to patent CL061752 by the same applicant as the present one, in which a machine is defined that allows safely loading siphons for whipped cream, such as Chantilly cream, by means of the automatic injection of nitrous oxide from nitrous oxide cylinders, comprising a cabinet divided into two zones or compartments. A first zone, which defines a space with its front part open, and a fixed piece intended to place the siphons to be loaded, where the nitrous oxide discharge assembly is located. A second zone, lower, rear, or lateral to the first, where inside the cabinet, in a non-visible way, are arranged the nitrous oxide cylinders to be used, at least one, and the pneumatic, electrical, and electronic connections, such as immobile flexible connectors, as well as sensors. A control panel is provided on the exterior of the cabinet, visibly. Said control panel includes a power selector, a display screen for variables, pilot lights, a start selector, a reset selector, and pressure gauges. A controller is also included, which works with signals from at least one infrared sensor to detect the siphon, with an ON/OFF switch and the start selector, and which commands the pilot lights, the display screen, and a solenoid valve. It also internally manipulates the variable of time during which the solenoid valve is activated and keeps a count of nitrous oxide charges performed, the dates, and provides the amount of nitrous oxide used within a time range. In another embodiment, optionally, a cellular, WIFI, or GPRS (General Packet Radio Service) or equivalent connection is defined, with the controller for remote operation monitoring.

In the previous embodiment, an important advance is achieved with respect to the prior art, optimizing in a safe way for operators and consumers the loading system of a creamer or kitchen siphon with nitrous oxide from a high-pressure cylinder, thereby exponentially increasing the availability of nitrous oxide, increasing efficiency in the use of the cream by reducing its losses, obtaining different cream textures through varying proportions of cream and nitrous oxide, as well as adequately monitoring the load and pressure of the nitrous oxide used. An important advantage compared to the most common siphon loading method, that is, with gas loading from a cartridge, is that with systems using cartridges it is not possible to adjust the gas-to-cream mixture without necessarily increasing the number of cartridges, that is, there is no control over the quality of the mixture in terms of its “aeration” from a single cartridge.

Currently, it is necessary to further improve the system and control for loading siphons; there is a need for a more compact machine with few components, allowing even greater safety and simplicity in its use, and additionally, that allows autonomous connection with an information base at all times regarding the use of the cylinders, which allows knowing exactly the autonomy of the equipment regarding the number of loads, thus knowing how much product remains in the cylinders to perform replacements.

The present invention arises from the need to optimize, in a safe way for the operator and the consumer, the system for loading a creamer or kitchen siphon with nitrous oxide from a high-pressure cylinder, thereby exponentially increasing the availability of nitrous oxide, increasing the efficiency in the use of the cream by reducing its losses, obtaining different cream textures through the different proportions of cream and nitrous oxide, as well as adequately monitoring the load and pressure of the nitrous oxide used. An important advantage of the machine is that it is compact and that the detailed status of each machine can be viewed, knowing the total number of loads, the date of the last load, and the use of the cylinder.

Having this information allows knowing exactly when a cylinder change is automatically required, thus enabling the management of logistics with greater efficiency and effectiveness.

In addition, complementary information is available regarding usage status, such as whether it is correctly connected, to manage a support visit to the machine.

### SUMMARY OF THE INVENTION

The present invention relates to the development of a compact machine for loading nitrous oxide into creamers or siphons, which comprises an information display that provides data about loads, which cylinder is in use, information transmission, and general machine settings. It also features a control panel and gas connections that make the machine simpler and more compact, increasing its lifespan and safety, since the connections remain fixed, with no movement required from the operator, and the working pressures of the components themselves are significantly increased.

A major advancement of the machine is that it can operate together with control software that incorporates “machine learning”, allowing data analysis and prediction of future behaviors, thereby enabling precise determination of when a cylinder will be depleted, through two predictive models: one based on time series and another on survival analysis, since the machine can interpret how it is being used and thus determine when the product should be exhausted. This new functionality also allows the estimation of “Frappuccino” sales, as the yield per siphon load is known—all in real time.

### BRIEF DESCRIPTION OF THE DRAWINGS

The present invention and its other features and advantages will become evident from the following description of a specific embodiment of the invention, provided with reference to the accompanying drawings, in which:

FIG. 1. Isometric view of the creamer machine in a first embodiment of the invention.

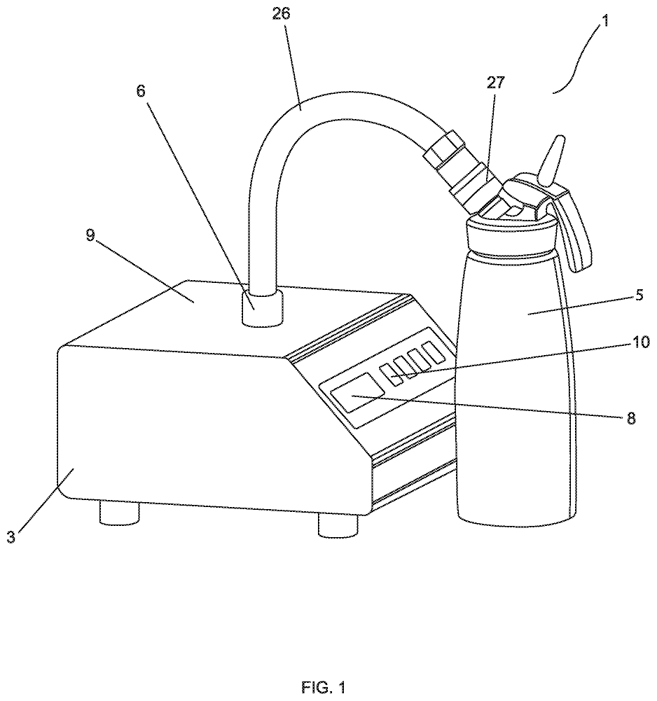

FIG. 2. Top exploded view of the creamer machine base.

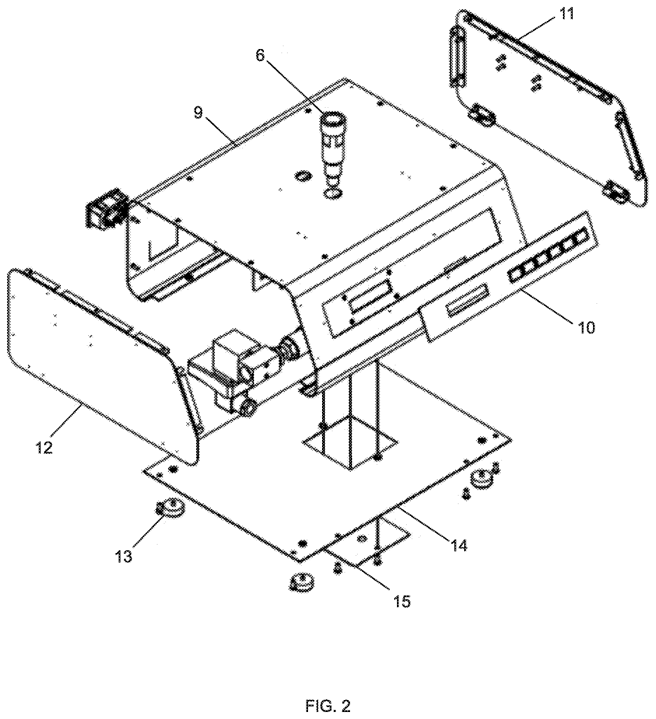

FIG. 3. Bottom exploded view of the creamer machine base.

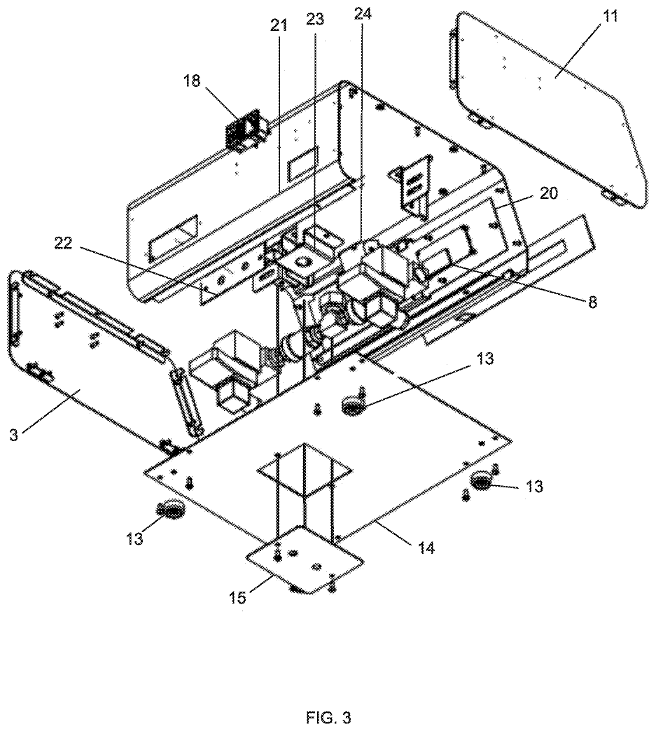

FIG. 4. Isometric view of a second embodiment of the invention.

### DETAILED DESCRIPTION OF THE INVENTION

The present invention offers multiple significant advantages, among which the following stand out:
Improved Safety: The inclusion of short-wave sensors ensures the correct connection of the siphon to the base. This prevents gas release in an uncontrolled environment, safeguarding the user's health. In addition, the incorporation of quick connectors at the end of the creamer reinforces this safety.
Size Reduction: A notable reduction of more than 80% in the total size of the machine has been achieved compared to previous models. This reduction has been made possible through the integration of innovative components, such as an electronic control board. This board allows remote operation of the machine, enables emergency stops, and compacts all components into a smaller space.
Integration of Machine Learning: Capable of (a) analyzing the speed of use of the loads and their daily repetition, contributing to the development of predictive models to determine cylinder autonomy, and (b) managing all processes in a secure, controllable, and compact space, thus adapting to the client's spatial requirements.
Main Informative Display: Shows system actions in real time, giving users a complete sense of control and helping prevent human errors. It also facilitates the calculation of the initial tare of the cream for precise portions.
Audible Alert: To signal key processes. This feature makes it easier to become familiar with the different stages of operation and allows other tasks to be performed while the siphon is being filled, thereby increasing production efficiency.
Customization: Certain aspects of the machine, such as audible alerts, cleaning processes, and the cylinder in use, can be customized. This flexibility ensures that clients can adapt the service to their specific needs.
Light and Visual Indicators: These indicators allow users to know the current state of their equipment. They also enable specialized technicians to quickly intervene for maintenance and replacement, not only of cylinders but also of parts subject to regular wear, thereby minimizing production downtime.

The creamer base is defined by a top wall, a bottom wall, side covers, and a rear cover preferably made of acrylic, defining a closed housing supported on skids. Additionally, the creamer base has a hose inlet cover from the loading cylinder, screwed to the outer surface of said bottom wall, and on the top wall there is a solenoid valve that regulates the supply of nitrous oxide to the siphon. The nitrous oxide loading hose is connected to this solenoid valve. Next to this hose, on the upper part, there is a generally circular or other-shaped weighing scale.

The front part of the creamer base comprises a display screen supported on a support plate, which allows displaying processes and providing information for complete control of each action carried out by the equipment, with light and visual indicators enabling users to identify the current state of the equipment, and a keyboard with seven buttons, configured in a “pull-up” arrangement, each potentially having a specific function: “start” button, “stop” button, “clean” button, “menu” button, “up” button, “down” button, and “left-right” button. Finally, an audible alert can be added to identify key equipment processes.

Inside the creamer base, there are connections for the solenoid valve that enable the passage of nitrous oxide to the siphon to perform mixture aeration; a sensor holder for an infrared sensor; and a connector for a power source, voltage regulators, electrical circuitry, and corresponding pneumatic lines and connections.

Inside the housing, the machine also contains the electronic circuitry, comprising an electronic control board that allows remote operation of the machine, emergency stops, and control of all components, as well as a main microprocessor that allows communication through light-emitting diodes (LEDs), controls relay activation, stops or starts processes, issues audible alerts, detects button presses and performs actions depending on the pressed button, detects the siphon's position, and controls master and slave microcontrollers for communication signal activation; a GPRS Sim900 device that, through a SIM card, communicates externally via phone calls, text messages, and, in this case, internet connection.

Both in the hose inlet cover at the bottom of the creamer base and in a hose inlet cover at the rear, connectors are defined for nitrous oxide loading cylinders.

Inside the housing, the machine also comprises electronic circuitry including an electronic control board that allows remote operation of the machine, enables emergency stops, and manages all components. A main microprocessor allows communication through LEDs, controls relay activation, stops or starts processes, issues audible alerts, detects button presses and performs actions depending on the pressed button, senses the siphon's position, and controls master and slave microcontrollers for communication signal activation; a GPRS Sim900 device that, through a Subscriber Identity Module (SIM) card, can communicate externally through phone calls, text messages, and in this case, internet connection.

Through a proximity sensor, the system detects when a user has installed the siphon in the compact creamer machine by sensing its position from a distance without physical contact, sending the information to the control board.

The external GPRS (General Packet Radio Service) module facilitates an autonomous and continuous connection with a computer database. This system transmits detailed real-time information about cylinder usage, making it possible to precisely monitor the equipment's autonomy, allowing an exact calculation of the remaining product in the cylinders and, consequently, determining the optimal time for replacement.

Additionally, it can integrate with control software enhanced with “machine learning” technology, which enables the analysis of data and prediction of future equipment behaviors. This provides highly accurate determination of when a cylinder will be depleted, using two predictive models: one based on time series and another on survival analysis. This functionality not only anticipates product depletion according to current usage but also facilitates precise estimation of whipped cream portion sales, by knowing the specific yield per siphon load, all managed in real time.

Through the programming implemented within the Microcontroller, the board can:
Communicate messages through light-emitting diodes (LEDs).
Control relay activation.
Stop or start processes.
Issue audible alerts.
Detect button presses and perform actions depending on the pressed button.
Sense the siphon's position.
Control the slave microcontroller.

In a preferred embodiment, a digital scale integrated on the surface of the machine base is incorporated, allowing the inclusion of the exact amounts of cream into the siphon. It is noteworthy that siphon-loading machines in the prior art do not include this device. Previous versions of siphon-loading machines lacked a system for weighing the ingredients included in the siphon. The scale, in principle, has a circular shape that fits the shape of the siphon to be refilled, although other shapes, such as square, hexagonal, etc., are not excluded.

The integration of a scale into the machine requiring ingredient weighing provides multiple benefits that are key to optimizing process efficiency and precision. This innovation saves significant time by eliminating the need to weigh ingredients separately, ensuring greater speed and fluidity in operations. Furthermore, it increases measurement accuracy, reduces human error, and guarantees consistency in ingredient proportions, which is vital to maintaining high product quality.

Automating the weighing process improves control and allows precise dosing. Another important benefit is the reduction of necessary space and equipment, as the need for a separate scale is eliminated—a crucial factor in limited spaces. Likewise, ingredient handling is minimized, reducing the possibility of cross-contamination and improving overall hygiene. This integration also facilitates inventory management and enhances staff training, making the process more intuitive and efficient. In summary, incorporating a scale into these machines represents a significant advance in operational efficiency, product quality, and hygienic ingredient handling.

Another relevant innovation in this siphon loader model is the inclusion of the loading hose together with a quick connection that simplifies and compacts the machine, increasing its lifespan and safety, since the connections remain fixed, allowing the machine operator to load the siphons with minimal manipulation and a high degree of safety due to the quick connection. This loading hose could be made of various materials and alloys, such as metal. In any case, the component should be made of a material that is durable and compatible with the working conditions of nitrous oxide.

One of the major advantages of this embodiment is the reduced likelihood of nitrous oxide leakage during recharging. Additionally, this reduction in leakage risk makes it possible to state that this design is safer than its prior art predecessors.

The quick connection head consists, among other things, of a threaded coupling comprising a part with external thread (male) and another with internal thread (female). These threads fit together. By turning the pieces in the correct direction, the threads interlock, providing a tight seal and a strong mechanical connection. However, the system also works with other types of quick connections such as pressure or push-fit couplings, quick-disconnect connectors, camlock (cam and groove) connectors, bayonet connectors, and hose couplings with clamps.

The advantages of these quick connection systems over traditional connections are speed in connection and disconnection, reduced losses due to leaks, ease of use, safety, compatibility and versatility, less wear, and adaptability to different pressures. In effect, the quick connection system would allow much faster coupling and uncoupling, which is crucial in situations where the machine needs to be changed or moved, as may be the case here. Furthermore, the quick connection system provides a very effective sealing mechanism, reducing the risk of gas leaks. This is especially important in the case of nitrous oxide. The quick connection system makes the machine easier to use and reduces downtime during maintenance.

In another embodiment, the compact creamer machine comprises an upper structure in which a transparent hatch with its corresponding handle for operation is installed, allowing the siphon to be coupled to the solenoid valve. This hatch keeps the siphon connection area isolated within the machine, in order to prevent the entry of foreign elements such as dust, insects, etc.

The machine's operating procedure is as follows:
Turn on the machine, which will start the LCD (liquid-crystal display) screen showing a welcome message, including the manufacturer's name, the name of the company contracting the service, a contact phone number in case of problems, and subsequently, the last load performed with the cylinder currently in use through an indicator LED on the front panel.
Place a siphon (previously filled with a product mixture at the appropriate temperature) in the central thread; an infrared sensor will detect its position. If the siphon is improperly screwed, filling will not be allowed, displaying an error message on the screen along with an audible alert; if everything is properly positioned, the screen will show a confirmation message.
Press the “START” button, activating the system that opens the solenoid valve and allows nitrous oxide to flow for 10 seconds to aerate the mixture.
Press “STOP” if any issue arises during this process, which will completely stop the system; “STOP” will also be activated if the siphon is removed before the filling time ends.
Remove the siphon once the process is completed.

After completing 600 loads per cylinder in use, the machine will switch to the next cylinder, indicating this on the display and sending the information to the main database to request a cylinder replacement, thus maintaining a constant nitrous oxide supply process.

The system also features an interactive menu, allowing free switching between cylinders and resetting them to zero load, verifying cylinder change operation, enabling/disabling cleaning every four loads, enabling/disabling sound, enabling/disabling the sensor, among others.

### Cream Preparation Procedure

Step 1: Tare the creamer without the lid, and add a few milliliters of vanilla syrup into the siphon.
Step 2: Add 330 ml of milk cream before closing the siphon with the lid.
Step 3: Verify that the rubber or seal of the siphon lid is in place; once verified, close the siphon and place it in the cold storage unit.
Step 4: Ideally, the cream should be maintained at a temperature between 1 °C and 4 °C, to achieve a perfect texture after loading in the machine.

### Standard Machine Procedure

To start the loading process, press the “start” button. Once pressed, a sound will be emitted and the screen will indicate the remaining loading time. After two sounds, the screen will indicate that the siphon should be removed; once removed, the siphon should be shaken six times and is then ready for dispensing portions of cream. Every four loads, the machine will indicate that the interior area where the siphon is placed must be cleaned; once cleaning is done, press the “clean” button to start a new load.

The “up” button allows movement in the indicated direction within the menu.

The “down” button allows movement in the indicated direction within the menu.

The “left-right” button, with an orange light on, indicates which cylinder is in use.

The “stop” button is for emergency use.

The “menu” button allows modification of the machine's characteristics.

### Loading Time

The optimal loading time is 10 seconds with the siphon connected to the machine. The machine operates with a high-precision regulator, as the regulator's output pressure is 30 bar toward the siphon, leaving 9.4 grams of nitrous oxide inside the siphon.

With reference to the figures, the compact creamer machine (1) is shown, comprising a creamer base (3) defined by a top wall (9), a bottom wall (14), side covers (11, 12), and a rear cover (21) preferably made of acrylic, defining a closed housing supported on skids (13). Additionally, the creamer base (3) includes a hose inlet cover (15) from the loading cylinder (not illustrated), screwed to the outer surface of said bottom wall (14), and on the top wall (9) protrudes a solenoid valve (6) that regulates the supply of nitrous oxide to the siphon (5).

In a preferred embodiment, the connection to the siphon is made through a quick connection system. This mechanism consists of a nitrous oxide loading hose (26) connected to the solenoid valve (6), whose loading end features a quick coupling to the siphon (5), which can be a threaded coupling (27) consisting of a part with an external thread (male) and another with an internal thread (female). These threads fit together. By turning the pieces in the correct direction, the threads interlock, providing a hermetic seal and a strong mechanical connection. However, the system could also work with other quick connection systems such as pressure or push-fit couplings, quick-disconnect connectors, camlock (cam and groove) couplings, bayonet connectors, or hose couplings with clamps.

Additionally, a scale (not illustrated) is included to allow incorporating the exact amounts into the siphon. In a preferred embodiment, the scale has a circular shape that fits the shape of the siphon to be refilled, integrated into the surface or top wall (9) of the creamer base (3) of the machine, allowing the operator to weigh the cream for precise loading.

The front part of the creamer base (3) comprises a display screen (8) supported on a support plate (20), which allows displaying processes and providing full control over each action carried out by the equipment, with light and visual indicators that allow users to identify the current state of the equipment, and a keyboard (10) with seven buttons configured in a “pull-up” arrangement, each with a specific function: “start” button, “stop” button, “clean” button, “menu” button, “up” button, “down” button, and “left-right” button. Finally, an audible alert is added to identify key processes of the equipment.

Inside the creamer base (3), there are connections for the solenoid valve (6) that enable the passage of nitrous oxide to the siphon to perform the aeration of the mixture; a sensor holder (23) for an infrared sensor, together with a connector for a power source (18), voltage regulators (24), electrical circuitry, and corresponding pneumatic lines and connections.

Also inside the housing, the machine includes the electronic circuitry comprising an electronic control board that allows remote operation of the machine, enables emergency stops, and manages all components; a main microprocessor that allows communication through light-emitting diodes (LEDs), controls relay activation, stops or starts processes, issues audible alerts, detects button presses and performs actions depending on the pressed button, senses the siphon position, and controls master and slave microcontrollers for communication signal activation; a GPRS Sim900 device that, through a SIM card, can communicate externally via phone calls, text messages, and, in this case, internet connection.

The proximity sensor allows detection of when a user has installed the siphon in the compact creamer machine by sensing its position, sending the information to the control board.

Both in the lower hose inlet cover (15) of the creamer base (3) and in a rear hose inlet cover (22), connectors are defined for nitrous oxide loading cylinders.

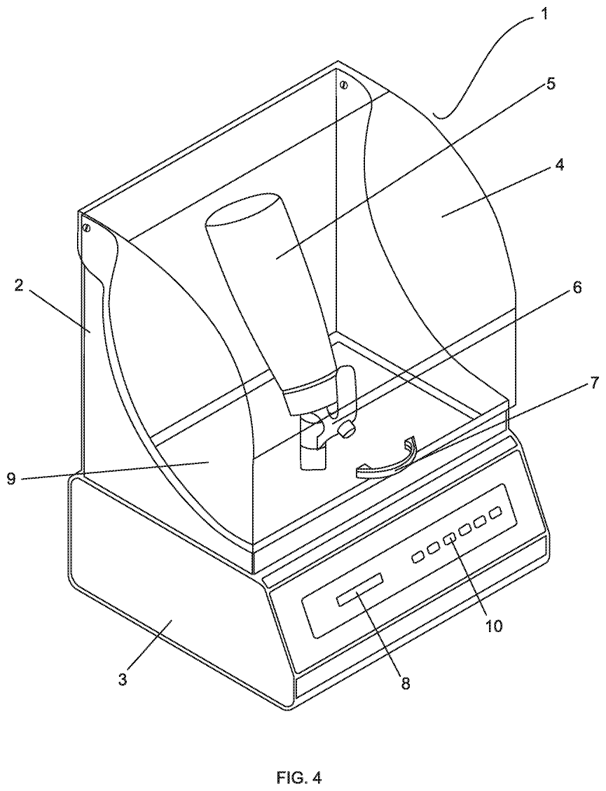

With reference to FIG. 4, another preferred embodiment of the compact creamer machine (1) is shown, comprising the same elements as the previously described embodiment, except that it does not include the quick connection hose and scale. In this embodiment, the compact creamer machine comprises a creamer base (3) with an upper structure (2), in which a transparent hatch (4) with its corresponding handle (7) is installed. In the upper structure (2), the siphon or creamer (5) is installed for loading with nitrous oxide.

### LIST OF PARTS

N^{o} Part
1 Portable creamer machine
2 Upper structure
3 Creamer base
4 Transparent hatch
5 Siphon
6 Solenoid valve
7 Handle
8 Display
9 Top base
10 Keyboard
11 Side cover
12 Side cover
13 Skids
14 Bottom base
15 Lower hose inlet cover
18 Connector for power source
20 Support plate
21 Rear cover
22 Rear hose inlet cover
23 Sensor holder
24 Voltage regulators
25 Open portable creamer machine
26 Nitrous oxide loading hose
27 Hose coupling

1. A compact creamer machine (1) for loading kitchen siphons for whipped cream by means of an automatic injection of nitrous oxide, installed or supported on an existing countertop, which allows maximizing cream portions, and wherein detailed status of the machine can be viewed, including a total number of loads, a date of the last load, and a cylinder usage remotely, further achieving the mixture between the cream and nitrous oxide in a correct proportions, reducing machine maintenance downtime, comprising:
a creamer base (3) defined by a top wall (9), a bottom wall (14), side covers (11, 12), and a rear cover (21) made of acrylic, defining a closed housing supported on skids (13), wherein the creamer base (3) further includes a hose inlet cover (15) from the loading cylinder, screwed to the outer surface of said bottom wall (14), and on the top wall (9) a solenoid valve (6) protrudes, regulating the supply to the siphon (5);
a quick connection system by means of a nitrous oxide loading hose (26) connected to a solenoid valve (6), having at its loading end a quick connection coupling to the siphon (27);
a digital scale next to the nitrous oxide loading hose, integrated on a surface of the creamer base (9).

2. The compact creamer machine (1) according to claim 1, wherein the quick connection coupling is a threaded coupling.

3. The compact creamer machine (1) according to claim 1, wherein the quick connection coupling is a pressure coupling selected from the group consisting of push-fit, quick-disconnect, camlock, cam and groove, bayonet, and clamp types.

4. The compact creamer machine (1) according to claim 2, further comprising a sealing means between the siphon and the quick connection coupling.

5. The compact creamer machine (1) according to claim 2, wherein the scale has a shape selected from the group consisting of circular, square, and hexagonal, adapted to the shape of the siphon to be refilled.

6. A compact creamer machine (1′) for loading kitchen siphons for whipped cream, by means of an automatic injection of nitrous oxide, installed or supported on an existing countertop, which allows maximizing cream portions, and wherein detailed status of the machine can be viewed, including a total number of loads, a date of the last load, and cylinder usage remotely, further achieving the mixture between the cream and nitrous oxide in the correct proportions, reducing machine maintenance downtime, comprising:
a creamer base (3) defined by a top wall (9), a bottom wall (14), side covers (11, 12), and a rear cover (21) made of acrylic, defining a closed housing supported on skids (13), wherein the creamer base (3) further includes a hose inlet cover (15) from the loading cylinder, screwed to the outer surface of said bottom wall (14), and on the top wall (9) a solenoid valve (6) protrudes, regulating the supply to the siphon (5);
an upper structure (2) open at a front, in which a transparent hatch (4) is installed, pivotable at an upper end of the upper structure, with its corresponding opening handle (7), wherein on the upper structure (2), supported on the base, the siphon (5) or creamer is installed for its nitrous oxide loading;
on the front part of the creamer base (3), a display screen (8) is defined, supported on a support plate (20), allowing display of processes and full control of each action carried out by the machine, with light and visual indicators enabling users to identify a current state of the machine, and a keyboard (10) having buttons configured in a “pull-up” arrangement, each with a specific function comprising a “start” button, a “stop” button, a “clean” button, a “menu” button, an “up” button, a “down” button, and a “left-right” button; and wherein an audible alert is added to identify the processes of the machine;
inside the creamer base (3), connections are provided for a solenoid valve (6), enabling the passage of nitrous oxide to the creamer for aeration of the mixture; a sensor holder (23) for an infrared sensor that detects the position of the siphon without contact, together with a connector for a power source (18), voltage regulators (24), electrical circuitry, and corresponding pneumatic lines and connections; and
inside the housing, an electronic circuitry with an electronic control board that allows remote operation of the machine, emergency stops, and management of all components; a main microprocessor that enables communication through light-emitting diodes (LEDs), controls relay activation, stops or starts processes, issues audible alerts, detects button presses and performs actions depending on the pressed button, senses the siphon position, and controls master and slave microcontrollers for communication signal activation; a GPRS Sim900 (General Packet Radio Service) device that, through a SIM (Subscriber Identity Module) card, can communicate externally via phone calls, text messages, and internet connection.

7. The compact creamer machine (1) according to claim 6, wherein a connector for a power source (18) is arranged at the rear part of the machine.

8. The compact creamer machine (1) according to claim 7, further comprising, on the lower hose inlet cover (15), a connector for a nitrous oxide loading cylinder.

9. The compact creamer machine (1) according to claim 8, further comprising a rear hose inlet cover (22) with a connector for a nitrous oxide loading cylinder.
